(19) United States
(12) Patent Application Publication
(10) Pub. No.: US 2012/0015771 A1
(43) Pub. Date: Jan. 19, 2012

(54) TRANSMISSION UNIT HAVING A TRANSVERSAL DEGREE OF FREEDOM

(75) Inventor: Felix Haeusler, Osnabrueck (DE)

(73) Assignee: ZF FRIEDRICHSHAFEN AG, Friedrichshafen (DE)

(21) Appl. No.: 13/258,659

(22) PCT Filed: Mar. 15, 2010
(86) PCT No.: PCT/DE10/50013

§ 371 Date: Sep. 22, 2011

(30) Foreign Application Priority Data
Apr. 1, 2009 (DE) 10 2009 002 089.6

(51) Int. Cl. F16H 57/08; F16H 13/06; B60K 7/00

(52) U.S. Cl. 475/149; 475/331; 475/183

(57) ABSTRACT

A transmission unit for a driven vehicle wheel comprising an input shaft having a pinion and an output shaft having a ring gear which are parallel so that the input and the output shafts can move transverse relative to one another. At least one planetary gearwheel engages the pinion and the ring gear and is supported by a planetary carrier such that the carrier, the pinion and the ring gear are coaxial with one another. A second carrier is supported coaxial with the ring gear such that the planetary gearwheel is axially arranged between the first and second carriers. The transmission unit enables transverse decoupling between the input and the output, and transmission of large torques. The transmission unit decouples wheel-hub motors from the wheel suspension, in relation to deflection movement of the driven wheel, which facilitates the reduction of the unsprung masses of a wheel-hub drive.

This application is a National Stage completion of PCT/DE2010/050013 filed Mar. 15, 2010, which claims priority from German patent application serial no. 10 2009 002 089.6 filed Apr. 1, 2009.

### FIELD OF THE INVENTION

The invention concerns a transmission unit, in particular for driving a vehicle wheel, such that the drive input and drive output shafts of the transmission unit can move transversely relative to one another.

### BACKGROUND OF THE INVENTION

Known transmission units transmit drive input torques, and have a drive input shaft can move transversely or in translation relative to the drive output shaft, or in which, while at the same time transmitting the torque, the drive input and drive output shafts can be moved essentially parallel relative to one another, are known. Examples of such transmission units are lateral shafts in wheel suspensions and cardan shafts, or special drive-trains with chains or belts.

However, such known transmission units with a translational degree of freedom of movement are on the one hand complex, and on the other hand take up considerable structural space—especially in the axial or radial direction—to achieve the transversal mobility of the two shafts relative to one another. Depending on the design, these known transmission units are also limited to a defined, generally rotational pivoting movement about a pivot point, and strictly speaking they do not therefore enable pure translational kinematics of the movement of the two shafts unless measures are adopted to compensate the length of the force transmission elements (belt, chain, cardan joint), which in turn entail additional structural complexity.

In the example case when such transmission units are used for driving the wheels of a motor vehicle, it is also necessary to consider the drive-train and wheel suspension/wheel guiding system as a whole, wherein the wheel suspension required for wheel guiding usually comprises a number of control arms, for example longitudinal, oblique and transverse control arms or tie-rods.

On the motor vehicle the associated drive-train usually comprises an internal combustion engine with a connected manual-shift or automatic transmission, one or two driveshafts and one or more differentials with their associated lateral shafts leading to the wheels. These assemblies—especially when they include the wheel-guiding control arms and lateral shafts and are therefore part of the wheel suspension system—take up quite a considerable amount of structural space in the area of the motor vehicle's wheels, this space then no longer being available for other purposes so that the room available for passengers, luggage or even technical assemblies is correspondingly reduced.

The assemblies in a conventional drive-train, in particular the wheel-guiding control arms and driveshafts, cannot be made arbitrarily smaller or shorter since this would result in unfavorable kinematic behavior in the deflection movement of the wheel.

Furthermore, developments in the drive-trains or drive systems of motor vehicles are increasingly directed toward hybrid concepts. These include in particular serial hybrids, in which there is no longer any mechanical connection between the internal combustion engine and the drive wheels. Instead, in a serial hybrid the internal combustion engine can for example power a generator which—if necessary is battery backed—in turn feeds electric motors connected to the drive wheels. A purely electric vehicle can also comprise a similar configuration, and in this case the energy is not supplied by an internal combustion engine but by an electrical energy accumulator; likewise, various mixed alternatives between serial hybrids and electric vehicles have been considered or already exist.

To keep the number of components needed for the transmission unit as small as possible and to minimize their space occupation and mass, in such vehicle designs it is sometimes sought to associate the driving electric motors directly with the wheels and accommodate them as near as possible to the wheels or even, in the form of wheel-hub motors, to fit them inside the wheels themselves. In this way a substantial number of parts of the conventional drive-train can be omitted or replaced by light and flexibly configured electric leads between the energy producer and the wheel-hub motors of the motor vehicle.

In addition efforts have already been made to accommodate the wheel suspension system itself with the associated spring/damper units within the inside space of the wheel rims or in the immediate vicinity of the wheels, so as in this way to gain even more space which, with conventional wheel suspensions, is otherwise needed for the known control arm structures.

From DE 698 06 444 T2 a wheel suspension that can be integrated in the rim of a wheel is known, with which in addition, for example electric drive motors can be accommodated at least partially in the inside space of the wheel rim. However, with this known wheel suspension system the electric drive motor is in each case attached fixed to the wheel carrier, so that the mass of the drive motor has to be added to the unsprung masses of the wheel suspension. Since, owing to the power required, the electric motors that can be used for a wheel-hub drive of a motor vehicle have considerable mass, they substantially increase the unsprung masses of the wheel suspension, with considerable adverse effect on the driving and suspension comfort, particularly since because of the large unsprung masses much stiffer shock absorbers have to be fitted.

From U.S. Pat. No. 2,182,417 a transmission unit for a vehicle is known, which attempts to solve the problem of desired transversal relative mobility of the drive input and output shafts of a wheel-hub drive by arranging the planetary gearwheels between a drive pinion and a drive output ring gear arranged on the output shaft, such that the planetary gearwheels are connected pivotably to the input shaft in each case by a supporting arm. This should enable permanent force transmission from the drive pinion, via the planetary gearwheels, to the ring gear, even when at the same time (for example due to deflection movements of the wheel) transversal movements between the drive pinion and the ring gear are taking place.

However, the technical principle known from that document is disadvantageous inasmuch as according to the principle of the document, the planetary gearwheels are suspended in each case by a single supporting arm, although in combination with a curved sliding guide for an axle stump of the planetary gearwheel concerned in the transmission housing. This, however, results only in a comparatively unstable and in certain positions also kinematically inadequate mounting of the planetary gearwheels, such that the planetary gearwheels are also mounted on only one side and, on the other side, engage with the teeth of the drive output ring gear only in a floating manner.

Thus, by means of this transmission unit known from the prior art only low torques can in any case be transmitted, since otherwise it can be reckoned that the only one-sided suspension of the planetary gearwheels will be overloaded and premature deflection of the planetary gearwheel sliding guide in the transmission housing will take place. Furthermore, owing to the deficient suspension of the planetary gearwheels in accordance with the principle of the document, it is unlikely that exact maintenance of the axial separation of the gearwheels required for transmission teeth of the present day would be possible for long. Accordingly, a transmission unit designed on the technical principle of the document could never be used in light of the torques or powers exerted per wheel in present-day motor vehicles.

### SUMMARY OF THE INVENTION

Against this background, the purpose of the present invention is to provide a transmission unit in particular for a vehicle wheel, which overcomes the disadvantages of the prior art. In particular, in the smallest possible space the transmission unit should enable transversal or translational decoupling between a drive input shaft and a drive output shaft. In this way it should in particular be made possible to decouple wheel-hub motors from the wheel suspension in relation to the jouncing movements of a wheel, and thus very substantially to reduce the unsprung masses of the wheel suspension. In addition, however, durable and reliable transmission even of high torques and powers should also be able to take place.

In a first manner known per se the transmission unit according to the present invention comprises a drive input shaft, and a drive output shaft arranged parallel to the drive input shaft. On the drive input shaft is arranged a drive pinion and on the drive output shaft an output ring gear. In a manner also known per se, the drive input and output shafts can be moved while parallel to one another in translation relative to one another—i.e. in the direction perpendicular to their respective rotation axes—in order in this way to be able to compensate for translational or transversal displacements between the drive input and drive output shafts—while at the same time transmitting torque. For this purpose the transmission unit comprises in particular at least one planetary gearwheel, which engages both with the drive pinion and with the output ring gear and which is mounted on a planetary axle of a planetary carrier. The planetary carrier, in turn, is mounted coaxially with the drive pinion and thus coaxially with the drive input shaft.

According to the invention, however, the transmission unit is characterized by a second planetary carrier also associated with the planetary gearwheel, which is associated with the same planetary axle supporting the planetary gearwheel as in the first planetary carrier. Thus, in the axial direction the planetary gearwheel is arranged between the first planetary carrier and the second planetary carrier, and the second planetary carrier is mounted coaxially with the output ring gear.

In other words this means in particular that according to the invention the two ends of the axle of the planetary gearwheel are held, respectively, each in a planetary carrier of its own. Thus, the planetary gearwheel is not—as in the prior art—mounted only floatingly on one side, while the other side in the prior art is mounted either not at all or only in an unstable sliding guide in the transmission housing.

Thus, according to the invention in this way the planetary gearwheel is always guided by the two planetary carriers—which are coupled to one another in a pivotable manner by means of their common planetary axle—in such manner that the planetary gearwheel is in permanent engagement both with the drive pinion and with the output ring gear. The first planetary carrier, which is mounted coaxially with the input shaft, ensures that the planetary gearwheel remains engaged with the drive pinion, while the second planetary carrier, which is mounted coaxially with the output ring gear, ensures that the planetary gearwheel remains permanently engaged with the output ring gear.

In this case it is advantageous, above all, that the transmission unit can be made very compact, since in principle it takes up as little space as does, for example, a conventional planetary transmission. Compared with other drive-trains known from the prior art which have a translational degree of freedom—such as lateral or cardan shafts—this results in a very substantially reduced occupation of structural space, which corresponds only to a fraction of the space taken up by other known solutions that can, respectively, withstand comparable torques.

Thus, at first sight the transmission unit according to the invention resembles a planetary transmission wherein the drive pinion corresponds to the sun gear, the planetary gearwheel to a planetary gearwheel of the planetary transmission, and the output ring gear to the ring gear of the planetary transmission. The difference from a planetary transmission (and also from the prior art described above), however, is that in the transmission unit according to the invention the planetary gearwheel is guided not just by one planetary carrier but by two separate planetary carriers coupled pivotably to one another, the first planetary carrier being mounted coaxially with the drive input shaft and the second planetary carrier mounted coaxially with the output ring gear, with the planetary gearwheel arranged in the axial direction between the two planetary carriers, and such that for their mutual coupling the two planetary carriers have a common planetary axis which in turn coincides with the axle of the planetary gearwheel.

For example, in contrast to a conventional planetary transmission, in the transmission unit according to the invention there is no circulatory rotation of the planetary carriers and the planetary gearwheel around the central suspension (there on the sun gear). Rather, the two planetary carriers of the transmission unit according to the invention serve to ensure co-ordinated pivoting motion of the planetary gearwheel both and simultaneously around the rotational axis of the drive input shaft and around the rotational axis of the output ring gear—while the planetary gearwheel is simultaneously and permanently engaged both with the drive pinion and with the output ring gear.

According to the invention, this provides the advantage that the drive input and drive output shafts with the drive pinion and the output ring gear can be moved in translation relative to and parallel with one another, while the transmission of large torques between the drive pinion and the output ring gear remains possible—regardless of the parallel displacement of the drive input and output shafts.

Thus, the invention is primarily based on the recognition that—particularly when a ring gear is used as the output ring gear—a second planetary carrier can be arranged in the ring gear mounted coaxially thereto in such manner that the planetary gearwheel can be arranged at the point of intersection of the two planetary carriers forming the planetary axle, and axially between the two planetary carriers. This results in exceptional rigidity of the mounting of the planetary gearwheel, since its axle is supported permanently at each end. In addition the damage-prone, ineffectual and only low-load-bearing mounting of the axle of the planetary gearwheel in the curved slide track in the transmission housing, known from the prior art, can be omitted. Thus, in contrast to the prior art, with the transmission unit according to the invention, powers or torques of the size that are common for the wheels of present-day motor vehicles can on the whole be transmitted.

According to a particularly preferred embodiment of the invention, the planetary axle common to the two planetary carriers is also made integrally with the first or with the second planetary carrier. This further increases the rigidity of the mounting of the planetary gearwheel, the production and assembly costs can be reduced, and the axial space occupied by the transmission unit can also be made smaller.

The invention can be realized regardless of how the mounting of the two planetary carriers is designed, provided that the two planetary carriers are mounted coaxially with the drive input and output shafts. In a particularly preferred embodiment, however, the first planetary carrier is mounted directly on the input shaft and the second planetary carrier in the ring gear directly on the output shaft.

This arrangement has the advantage of taking up minimal space, particularly in the axial direction, since almost the entire transmission unit can be arranged within the inside space of the ring gear.

In principle the invention can be realized largely independently of the size and tooth-number ratios between the drive pinion, the planetary gearwheel and the output ring gear, provided that gearwheel engagement is ensured.

However, according to a particularly preferred embodiment of the invention the first planetary carrier and the second planetary carrier have the same effective radius. This means, in other words, that the radial distance between the drive input shaft and the axle of the planetary gearwheel matches the radial distance between the drive output shaft and the axle of the planetary gearwheel, so that the axle of the planetary gearwheel is the same distance away from the drive input and drive output shafts.

This embodiment is advantageous inasmuch as in this way the maximum translational freedom of movement between the drive input and output shafts is achieved. Moreover, a further advantage is obtained in that by arbitrary translational movements between the input and output shafts within the freedom of movement range of the transmission unit according to the invention, for geometrical reasons no rotational speed errors between the input and output shafts are induced. This is related to the fact that the planetary carriers of the transmission unit, in this case having the same effective radius, are pivoted during any transversal movement essentially through the same angle, whereby induced rotational angle or rotational speed errors occur only within the transmission unit but are fully compensated for toward the outside.

In a further, particularly preferred embodiment of the invention, the planetary carriers are formed only as pivoting levers each having two mounting joints. This embodiment too favors a particularly compact design of the transmission unit according to the invention. In this embodiment the planetary carriers are thus functionally reduced to their task, namely to connect the planetary gearwheel of the transmission unit to the drive input shaft and to the drive output shaft, and to mount it pivotably relative to the input and output shafts, while at the same time ensuring the correct distance between the planetary gearwheel and the drive pinion between the planetary gearwheel and the output ring gear so that the tooth engagement takes place even during transverse movements.

According to a particularly preferred embodiment of the invention, the transmission unit comprises two planetary gearwheels and four planetary carriers. In this case each planetary gearwheel is associated with a pair comprising a first planetary carrier and a second planetary carrier. In this embodiment even higher power and torque transmission is achieved by virtue of the two planetary gearwheels; in the neutral position of the transmission unit the two planetary gearwheels are preferably arranged opposite one another in relation to the input shaft. Owing to the resulting at least partial removal of radial tooth forces on the two planetary gearwheels, in this embodiment mutual support of the two planetary gearwheels between the drive pinion and the ring gear is also obtained, and thus, overall, still better rigidity of the gearwheels arrangement of the transmission unit.

Preferably, in this case the two planetary carriers associated with the second planetary gearwheel are each mounted coaxially with the two planetary carriers associated with the first planetary gearwheel. Thanks to this coaxial mounting of the planetary carriers associated with the second planetary gearwheel relative to the planetary carriers associated with the first planetary gearwheel, axial structural space is saved and in addition mounting with greater overall rigidity is obtained in relation to the planetary carrier arrangement consisting in this case of four planetary carriers.

A further preferred embodiment provides that the transmission unit is designed as a wheel drive and is integrated in a wheel rim, such that the output ring gear is at the same time connected directly to the wheel hub. Preferably, the transmission unit is then also designed as a wheel-hub drive and is directly connected to a drive motor.

This enables an exceptionally compact wheel-hub drive to be obtained, which above all has the decisive advantage of permitting vertical deflection movements of a driven wheel completely without interference without the need, for this, to provide the usually necessary drive elements such as lateral shafts or chain drives. Instead, in this embodiment the transmission unit according to the invention enables free—especially vertical—deflection movement of the driven wheel, whereas at the same time the driveshaft of the wheel emerging in the wheel hub does not follow the vertical movement of the wheel but rather, in relation to the vehicle, can be fixed in the vertical direction. Thus, without the interposition of lateral shafts the driveshaft of the wheel can for example be mounted directly on the vehicle chassis or connected directly to an axle drive or wheel drive.

In the case when the transmission unit according to the invention is designed as a wheel-hub drive with a directly connected drive motor, the decisive advantage is also obtained that the drive motor—although for example arranged directly on the wheel hub—does not have to be connected fixed to the wheel hub or to the wheel carrier, but in relation to the deflection movement of the wheel, can be completely decoupled therefrom. In other words, this means that the drive motor of a wheel-hub drive comprising the transmission unit according to the invention can in particular be arranged fixed on the body or chassis, while the driven wheel can undergo its deflection movements uninfluenced by the drive. In this way the disadvantages of wheel-hub drives known from the prior art, in which the drive motor is added to the unsprung masses of the wheel suspension, is eliminated. Thus, thanks to the invention it is possible to produce a torque-withstanding wheel-hub drive which offers suspension comfort comparable to that of an ordinary wheel suspension.

As the drive motor of the wheel-hub drive, in principle any type of motor can be used. For example, even a hydraulic motor can be considered. However, particularly with the background of using the transmission unit according to the invention in the context of passenger cars with an electric or hybrid drive, according to an especially preferred embodiment of the invention it is provided that the drive motor of the wheel-hub drive is an electric motor.

In this way a very compact electric wheel-hub drive is obtained, which can be supplied with current produced, for example, from a battery or from an internal combustion engine with generator.

In such a case the motor shaft of the drive motor preferably forms the drive input shaft directly, and the drive pinion of the transmission unit is arranged directly on the motor shaft. In this way the drive motor can be arranged directly on the driven wheel or, depending on the shape and size of the drive motor and the wheel rim, even within the wheel rim.

In another, particularly preferred embodiment of the invention the transmission unit is arranged in a wheel carrier, which is at the same time designed as the transmission housing. This gives a particularly compact and robust design of the transmission unit made as a wheel-hub drive, since the gearwheels of the transmission unit can be arranged in the inside space of the wheel carrier designed as a transmission housing.

Particularly against the background of a drive motor attached directly to a transmission unit according to the invention, an elastic bellows with a radial and transversal degree of freedom of movement is provided between the shaft side of the drive motor and the transmission unit. In this way, relative movements that take place between the wheel and the transmission unit, on the one hand, and the drive motor arranged on the vehicle chassis, are compensated, while at the same time the driveshaft of the motor and the transmission unit are protected against environmental influences.

In the first place, the invention can be realized regardless of the design of the transverse relative movement between the drive input and the drive output shafts. In the example case of its use in a wheel suspension, the transverse relative movement of the transmission unit can, for example, be realized by an arrangement of control arms known per se.

However, in an alternative embodiment of the invention the transmission unit comprises a linear guide or is connected to a linear guide. This linear guide ensures a purely linear translational or transversal relative movement between the drive input and drive output shafts, so the degree of freedom of movement between the drive input and output shafts is correspondingly restricted to the desired translational movement. Such a linear guide is advantageous inasmuch as, compared with control arm arrangements, it takes up only a minimum amount of (axial) space, which can be particularly important in the case of wheel suspensions in which the linear guide of the transmission unit therefore on the one hand ensures linear transverse mobility between the drive input and output shafts, and on the other hand forms the wheel suspension itself.

Here, bearing housings for the bearing bushes of the linear guide can for example be made integrally with the wheel carrier or connected directly to the wheel carrier. In this way the wheel carrier can not only fulfill the functions of guiding and mounting the wheel and encapsulating the transmission unit according to the invention, but it also forms the moving portion of the wheel suspension. In other words, this means that the bearing housings of the linear guide in which, for example, the sliding surfaces or bearing bushes of the linear guide are arranged, can be formed in one piece with the wheel carrier or connected directly to the wheel carrier, which enables a torsionally rigid and lightweight design of the wheel suspension.

Particularly in the case when the transmission unit is designed as a compact wheel-hub drive which also comprises the above-described linear guide for suspending the wheel, the structural space needed for a driven wheel of a motor vehicle, including its drive and suspension, is very much reduced, sometimes to a fraction of the space taken up by conventional drive-trains and wheel suspensions.

However, when greater demands are made on the kinematics of a wheel suspension, for example in sporty vehicles, the transmission unit according to the invention in the form of a wheel carrier and part of a wheel-hub drive can also be arranged on the vehicle by means of a control arm arrangement. Having this in mind, a further embodiment of the invention provides that between the drive pinion of the transmission unit and the drive motor of the wheel-hub drive at least one shaft compensation joint is arranged. With this compensation joint the slight axial length variations and slight angle differences that can occur during deflection of the vehicle wheel, when the wheel is connected to the vehicle chassis not by means of a linear guide but by an arrangement of wheel guide control arms, can be compensated.

To ensure suitable and reliable torque transmission in all operating conditions of the transmission unit, according to another embodiment of the invention it is provided that a torsion prevention device is arranged on at least one of the planetary carriers. The torsion prevention device is designed such that in the neutral position of the transmission unit, i.e. when the drive input and drive output shafts overlap axially, an otherwise possible rotation of the planetary carrier and thus also of the planetary gearwheels about the, in this case, overlapping axes of the drive input and output shafts, and thus an interruption of the torque transmission, is prevented.

Following what has been said, those with an understanding of the subject will be able to see that the kinematic principle of the invention is not limited to gearwheel transmissions. With this background, according to an alternative embodiment of the invention it is provided that instead of gearwheels the transmission unit has friction wheels, whose diameter ratio can in particular be chosen so as to be proportional to the tooth-number ratios of the gearwheels of the transmission unit.

### BRIEF DESCRIPTION OF THE DRAWINGS

Below, the invention is explained in more detail with reference to drawings that illustrate embodiments presented only as examples, and which show:

FIG. 1: An isometric representation of an embodiment of a transmission unit according to the invention, in this case integrated in a wheel-hub drive with a linear guide;

FIG. 2: The wheel-hub drive with transmission unit according to FIG. 1, with the drive motor removed;

FIG. 3: A representation corresponding to FIG. 1 and FIG. 2, showing an embodiment of a transmission unit according to the invention as a wheel-hub drive with a control arm arrangement for wheel guiding;

FIG. 4: A representation corresponding to FIG. 1 and FIG. 3, showing the wheel-hub drive with transmission unit according to FIG. 3, with the transmission housing cover removed;

FIG. 5: The transmission unit of the wheel-hub drive according to FIGS. 3 and 4, shown as an enlarged section;

FIG. 6: An axial section of the wheel-hub drive with its transmission unit, as in FIGS. 3 to 5;

FIG. 7: A schematic side view of the wheel-hub drive with transmission unit as in FIGS. 3 to 6, with the wheel in the fully extended sprung condition;

FIG. 8: A view corresponding to FIG. 7, showing the wheel-hub drive with transmission unit as in FIGS. 3 to 7, with the wheel in the neutral sprung condition; and

FIG. 9: A view corresponding to FIGS. 7 and 8, showing the wheel-hub drive with transmission unit as in FIGS. 3 to 8, with the wheel in the fully compressed sprung condition.

### DETAILED DESCRIPTION OF THE PREFERRED EMBODIMENTS

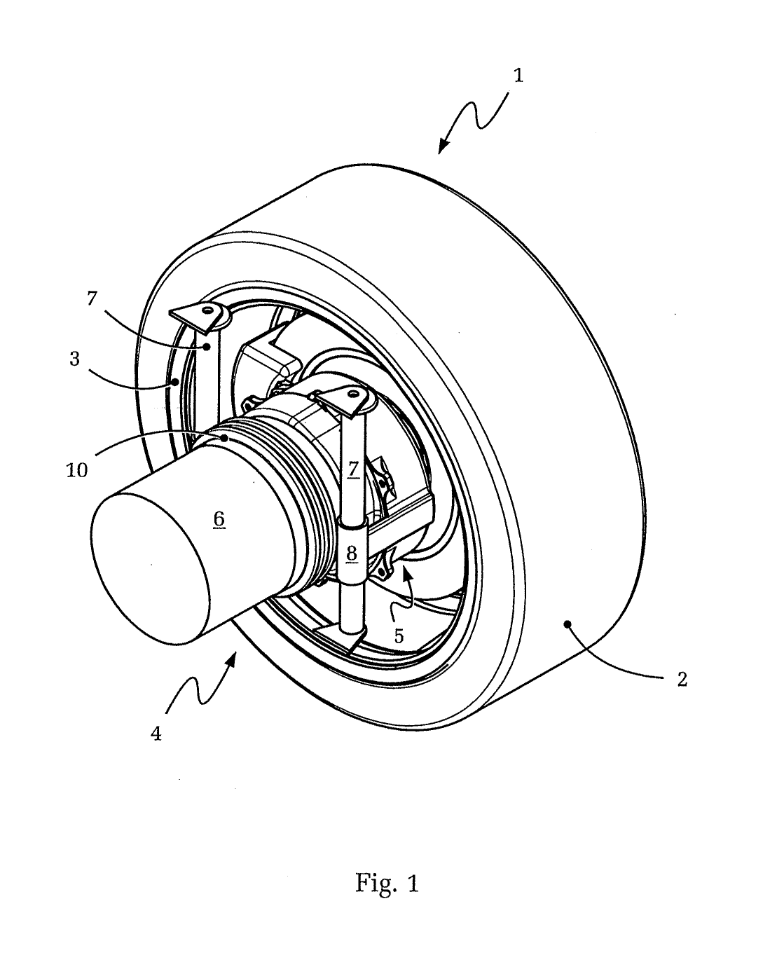

FIG. 1 shows an isometric representation of an embodiment of a transmission unit according to the present invention, in this case formed as a wheel-hub drive or integrated in a wheel-hub drive.

The figure shows, first, a vehicle wheel 1 with a tire 2 and a rim 3, and in addition a wheel-hub drive 4 with a transmission unit 5 and a drive motor 6. The wheel-hub drive 4 illustrated is also equipped as a wheel suspension with a linear guide 7, 8 represented only schematically, which in the embodiment illustrated comprises two guide rods 7 and two bearing housings 8. The bearing housings 8 serve as or contain guide bushes and can thus slide up and down in the vertical direction on the guide rods 7 fixed to the chassis. For clarity of representation, springs/damper units also belonging to the wheel suspension are not shown in the figures.

Since the drive motor 6 (like the guide rods 7) is connected fixed to the vehicle chassis (not shown), whereas the wheel 1 with the transmission unit 5 according to the invention can undergo vertical deflection movements 9, between the drive motor 6 and the transmission unit 5 there is arranged a bellows 10 that is elastic in the radial and transversal directions, which protects the drive input shaft 11 against dirt during relative movements between the wheel 1 and the drive motor 6.

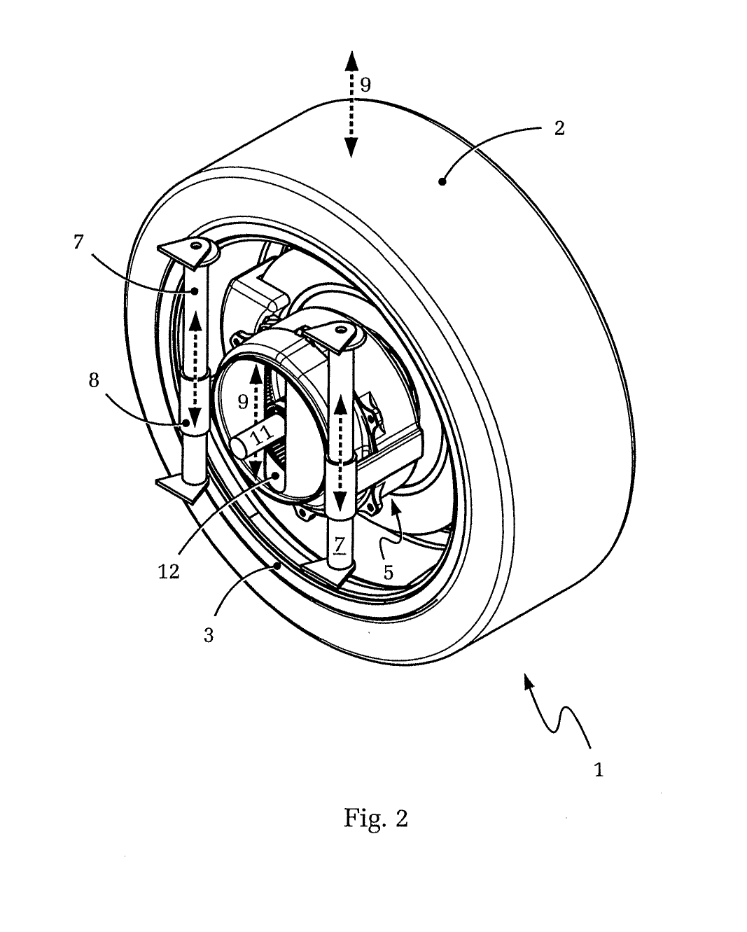

FIG. 2 shows the wheel-hub drive of FIG. 1, with the drive motor 6 removed to allow better visibility of the transmission unit 5. In addition to the elements already shown in FIG. 1, in FIG. 2 the drive input shaft 11 of the transmission unit 5 can be seen in particular. By virtue of the slot-shaped elongated hole 12 in the housing of the transmission unit 5, transverse articulation 9 of the drive input shaft 11 relative to the housing of the transmission unit 5 or relative to the driven wheel 1 is made possible as indicated in FIG. 2 (see the broken double-arrow 9 in FIG. 2).

This means that the drive input shaft 11 (and the drive motor 6, whose shaft is here identical with the driveshaft 11), like the guide rods 7 of the linear guide 7, 8, are positioned fixed on the chassis, while the other parts of the transmission unit 5, the housing of the transmission unit and the driven wheel 1, can undergo vertical deflection movements 9.

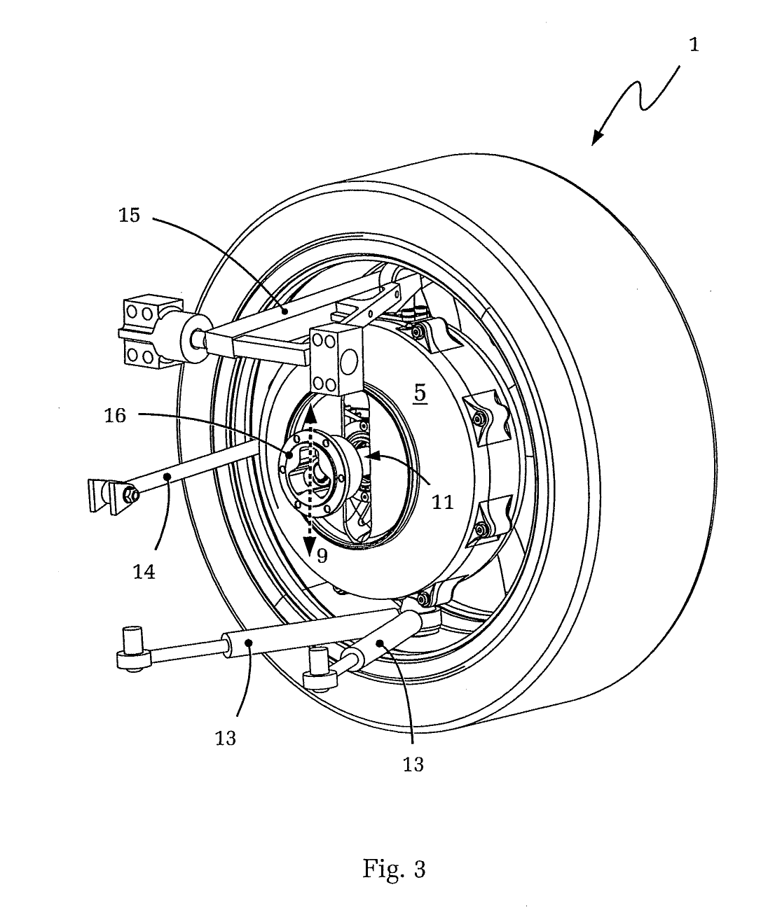

FIG. 3 shows another embodiment of a transmission unit 5 according to the invention. In FIG. 3 the transmission unit 5 is again integrated in a wheel-hub drive, but in contrast to the example embodiment shown in FIGS. 1 and 2 the wheel suspension takes place not by means of a linear guide, but by virtue of an arrangement of wheel guide control arms 13, 14, 15. In a manner known per se, the wheel guide control arms 13, 14, 15 are at one end each connected elastically or articulated to the chassis of the motor vehicle (not shown), while at their ends on the wheel side they are likewise connected elastically or articulated to the transmission unit 5, which in this case at the same time forms the wheel carrier.

The result of suspending the vehicle wheel 1 by means of an arrangement of control arms 13, 14, 15 is that when the vehicle wheel 1 jounces, in addition to the vertical and, relative to the drive input shaft, transversal movements of the vehicle wheel 1 slight lateral and, relative to the drive input shaft 11, axial movements of the vehicle wheel 1 take place. Depending on the exact geometry of the wheel guide control arms 13, 14, 15, jouncing can also result in a slight variation of the wheel camber. This means that in the embodiment with wheel guide control arms 13, 14, shown here, the deflection movement of the vehicle wheel 1 does not take place exclusively vertically and in a linear manner.

For this reason, in this embodiment a compensating joint 16 is arranged between the driveshaft 11 of the transmission unit 5 and the drive motor (not shown here, but see FIG. 1), which when the wheel jounces, takes up or compensates for the slight axial displacement and any slight camber angle deviations caused by the wheel guide control arms 13, 14, 15. In this way too, however, according to the invention the purely vertical component 9 of the deflection movement is absorbed and compensated completely within the transmission unit 5.

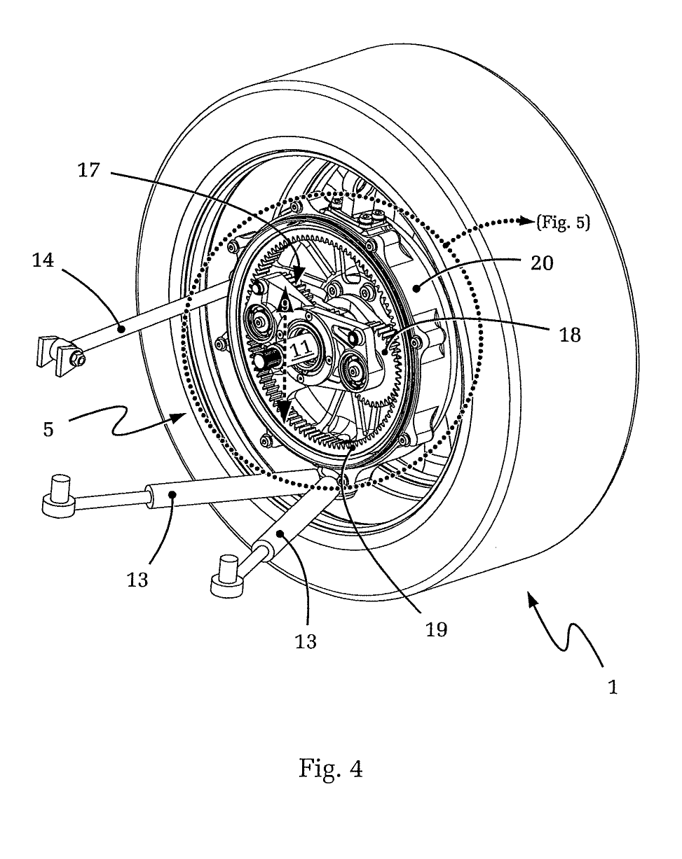

FIG. 4 shows the transmission unit 5 of the wheel-hub drive according to FIG. 3, with the transmission housing cover removed. One can already see some essential parts of the transmission unit 5, namely two planetary gearwheels 17, 18 and the drive output ring gear 19—bolted to the wheel hub. The output ring gear 19 is enclosed by the wheel carrier at the same time forming the transmission housing 20, which at the same time forms or carries the joint holders to which the wheel guide control arms 13, 14, 15 are attached.

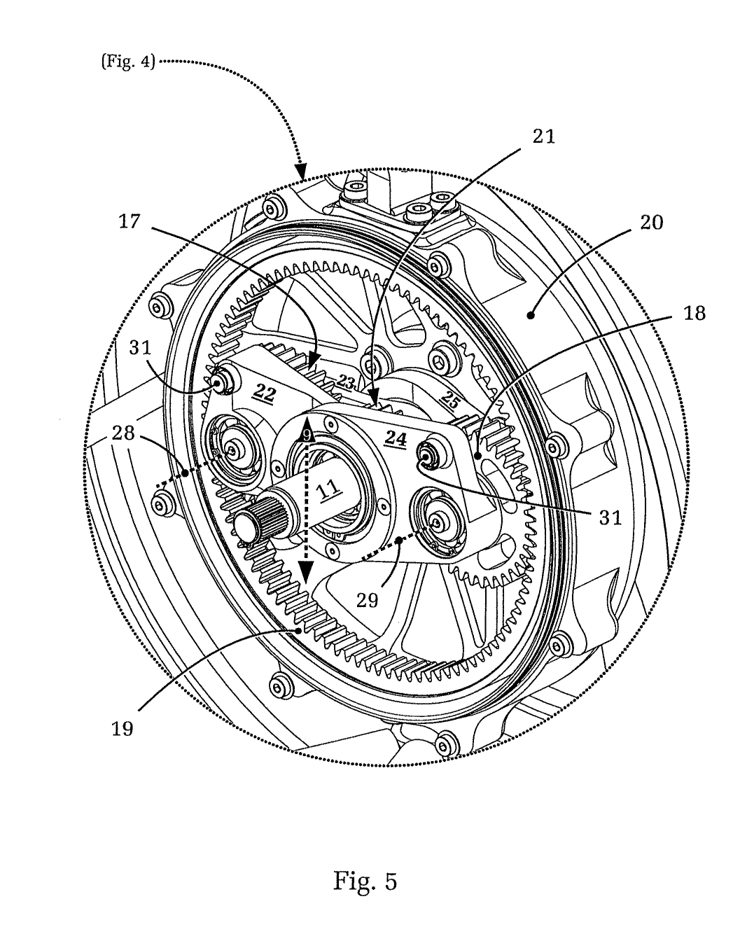

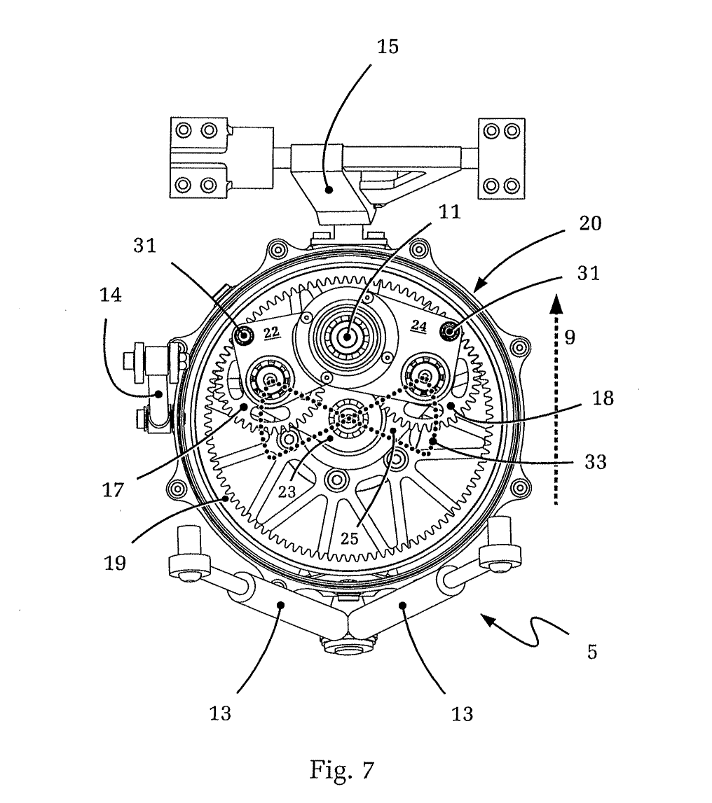

For the sake of better visibility the transmission unit 5 of FIG. 4 is shown in an enlarged section in FIG. 5. In particular one can again see the two planetary gearwheels 17, 18 and the output ring gear 19. The drive pinion 21 of the transmission unit 5 that sits on the drive input shaft can also be partially seen in FIG. 5. Also clearly visible in FIG. 5 are the total of four planetary carriers 22, 23 and 24, by which the two planetary gearwheels 17, 18 are guided in such manner that the planetary gearwheels 17, 18 are at all times engaged both with the drive pinion 21 and also with the output ring gear 19, and this even when the driveshaft 11 with the drive pinion 21 and the vehicle wheel 1 with the output ring gear 19 undergo vertical relative movements 9 in relation to one another during deflection, as shown in detail in FIGS. 7 to 9.

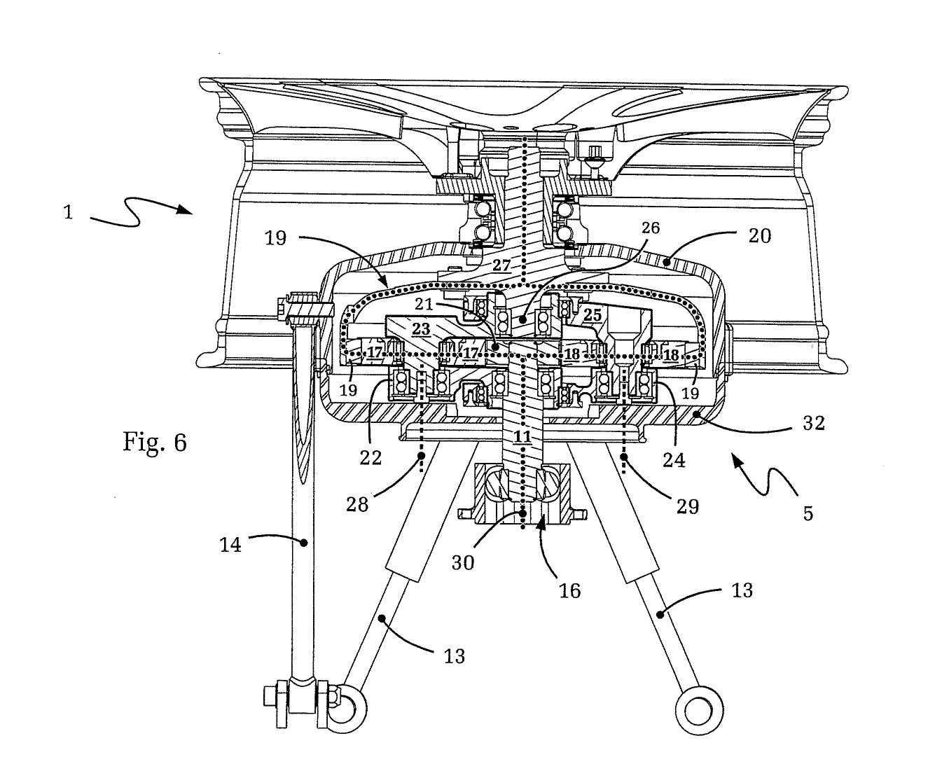

In the embodiment illustrated in FIG. 5, the planetary carriers 22, 23 and 24, are essentially formed as pivoting levers, each with two mounting points. As can be seen particularly clearly by inspecting FIGS. 5 and 6 together, the two planetary carriers 22, 23 at the front in relation to the drawing are mounted coaxially on the driveshaft 11, while the two planetary carriers 24, 25 at the rear in relation to the drawing are mounted in the inside space of the output ring gear 19 coaxially on a stub axle 26 connected to the output ring gear 19, which is in turn formed integrally with the wheel hub 27.

The respective axes 28, 29 of the planetary gearwheels 17, 18 are at the same time formed by the respective two common planetary axes 28, 29 for the two planetary carriers 22, 23 and 24, 25 respectively associated with the planetary gearwheels 17 and 18. Thus, the first planetary carrier 22 or 24 associated with a planetary gearwheel 17, 18 ensures a constant distance and tooth engagement between the drive pinion 21 and the planetary gearwheel 17 or 18, while the second planetary carrier 23 or 25 associated with the same planetary gearwheel 17 or 18 ensures a constant distance and tooth engagement between the planetary gearwheel 17 or 18 and the output ring gear 19.

Thus, this means that as in FIG. 5 the driveshaft 11 and wheel axle or output ring gear 19 can undergo a transversal movement 9 relative to one another in the vertical direction in relation to the drawing (see the double-arrow 9), while at the same time the tooth engagement of all four gearwheels 21, 17, 18, 19 and hence the full torque transmitted between the driveshaft 11 and the output ring gear 19 is maintained at all times. Thus, the wheel 1 with the wheel carrier or transmission housing 20 can again undergo the vertical deflection movements 9, while the driveshaft 11 and hence the drive motor 6 (see FIG. 1) can essentially be connected solidly to the vehicle chassis, and accordingly and advantageously, constitute sprung masses of the motor vehicle.

Thus, with the transmission unit the force flow of the drive input torque passes, starting from the driveshaft 11, via the drive pinion 21 firmly connected thereto, and from there to the two planetary gearwheels 17, 18; and in turn, from the planetary gearwheels 17, 18 to the output ring gear 19 connected firmly to the vehicle wheel 1. The latter can be seen particularly clearly by inspecting FIG. 5 and the sectioned representation in FIG. 6 together, the force flow in the representation of FIG. 6 being indicated by a dotted line 30. As described, the force flow 30 is maintained unchanged regardless of how the driveshaft 11 with its drive pinion 21 moves relative to the vehicle wheel 1 (see the broken double-arrow 9 in FIG. 5 and the representation of the relative movement between the vehicle wheel 1 and the driveshaft 11 and the drive pinion 21, shown in FIGS. 7 to 9).

FIG. 6 shows the wheel-hub drive with the transmission unit 5 according to FIGS. 4 and 5, viewed in longitudinal section along the wheel axis or wheel hub 27. In this case the wheel hub 27 at the same time forms the drive output shaft of the transmission unit 5, and in the transmission position shown in FIGS. 4 to 6 and 9, is arranged in a coaxial relative position in relation to the driveshaft 11 of the transmission unit 5. In the sectioned view of FIG. 6, also clear to see is the housing 20 of the transmission unit 5, which at the tame time constitutes the wheel carrier and so also carries the attachment points for the wheel guide control arms 13, 14, shown in FIGS. 3 and 4.

In FIG. 6 can be seen, directly inside the housing wall 20 of the transmission unit 5, the drive output ring gear 19 which is connected in a rotationally fixed manner to the wheel hub 27 of the vehicle wheel 1. Inside the ring gear 19 can be seen the planetary gearwheels 17, 18 represented in section. The two planetary gearwheels 17, 18 are held by means of the first pair of planetary carriers 22, 24 in tooth engagement with the drive pinion 21, and at the same time by means of the second pair of planetary carriers 23, 25 on the pivoting planetary position 33 (see the curve segment 33 in FIGS. 7 to 9) and in tooth engagement with the output ring gear 19.

An inspection of FIG. 5 and FIG. 6 together also makes clear the design of the four planetary carriers 22, 23, 24, 25 which, to assist identification, are outline with bolder lines in FIG. 6. Particularly in FIG. 6 it can be seen that the axes 28, 29 of the two planetary gearwheels 17, 18 are formed, respectively, by extensions of the two planetary carriers 23, 25 on the wheel side, these axes or extensions each being formed integrally with the respective planetary carrier 23, 25. This results in particular in a very compact structure in the axial direction and high torsional rigidity of the transmission unit 5.

Furthermore, particularly in the sectioned view shown in FIG. 6 it can be seen that the two planetary carriers 22, 23 on the left in the drawing that guide the planetary gearwheel 17 are mounted directly on the driveshaft 11 and on the stub axle 26 of the drive output ring gear 19, while for their part the other two planetary carriers 24, 25, on the right in the drawing and which guide the planetary gearwheel 18, are each mounted on the bearing points of the first two planetary carriers 22, 23. This too results in a particularly compact structure in the axial direction and increases the rigidity of the overall arrangement of the planetary carriers 22, 23 and 24, 25.

In the case of the pictured relative position of the four gearwheels 21, 17, 18, 19—i.e. for example when during a jouncing movement 9 the driveshaft 11 and the output shaft 27 are positioned exactly coaxially with one another—in some circumstances the position of the planetary gearwheels 17, 18 can be kinematically under-regulated. In such an event the two planetary gearwheels 17, 18 and the four planetary carriers 22, 24 and 23, 25 then positioned parallel in pairs—as in a planetary transmission—could rotate around the then coaxial axes 11, 27 of the driveshaft 11 and the output ring gear 19, which is here undesirable since in that case the torque transmission would be interrupted and the transmission 5 could then find itself in an undefined condition.

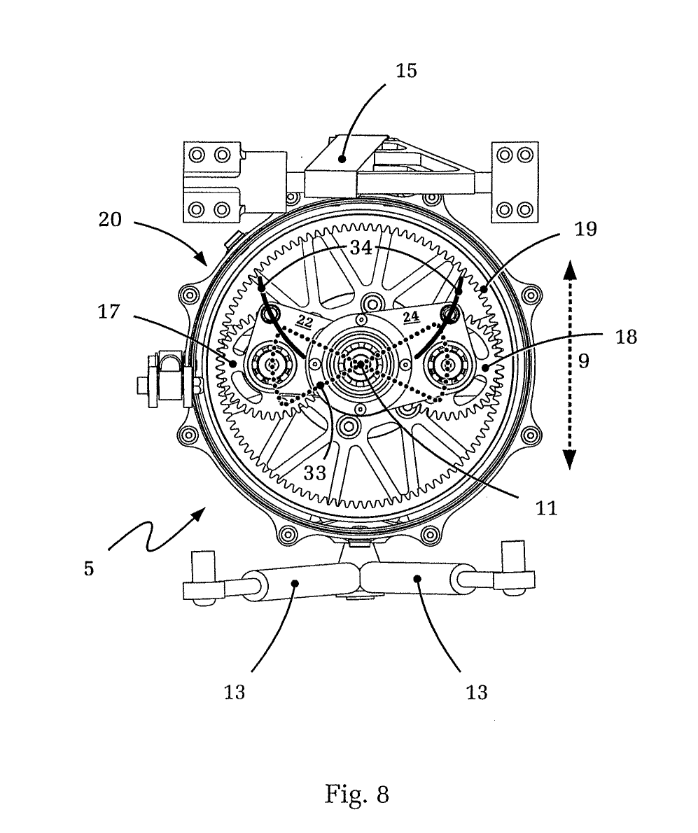

To prevent this kinematic under-regulation of the planetary gearwheels 17, 18 in their relative position shown in FIG. 5, in the embodiment illustrated two locking pins 31 are arranged on the two planetary carriers 22, 24 at the front relative to the drawing. In the immediate area of the medium-sprung position of the driveshaft 11 shown in FIGS. 5, 6 and 8 the locking pins 31 engage in a suitably shaped locking slideway which, for greater simplicity, is not shown in FIG. 5. However, the approximate course of the locking slideway is indicated in FIG. 8 (see index 34 therein).

By virtue of the engagement of the locking pins 31 in the locking slideway 34—for example arranged in the housing cover 32 of the transmission housing 20—it can be ensured that in the area of the middle position of the driveshaft 11 illustrated (see also FIG. 8) the planetary carriers 22, 24 can undergo their pivoting movement—as during deflection movements of the wheel—only around the planetary axes 28, 29 as momentary axes, but cannot (in the manner of a planetary transmission) undergo a rotation around the driveshaft 11. Thus, thanks to the locking pins 31 and their engagement in the corresponding locking slideway 34 in the housing cover 32, the kinematic under-regulation of the rotation position of the planetary gearwheels 17, 18—in the pictured coaxial position of the drive input shaft 11 and the drive output shaft 27—around the driveshaft 11 can be eliminated, and full torque transmission in any relative positions of the driveshaft 11 and the output shaft 27 can be ensured.

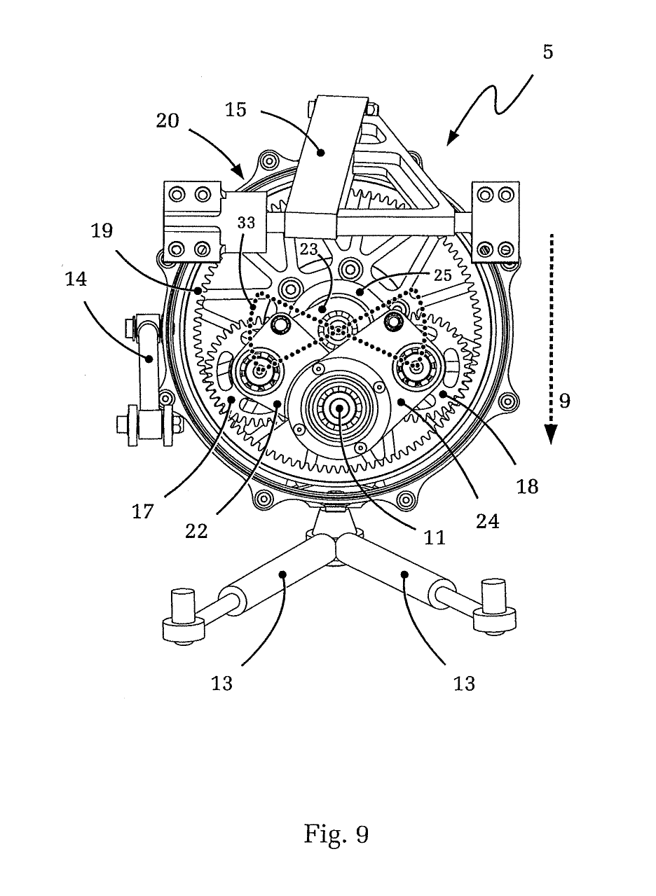

FIGS. 7 to 9 show the course of a deflection movement of the driven wheel 1 between sprung conditions of full extension (FIG. 7), the neutral position (FIG. 8) and full compression (FIG. 9). Here, the vehicle-side ends of the wishbone 13, 15 shown in FIGS. 7 to 9 and the additional track-rod 14 are in each case attached to the chassis, while the wheel-side ends of the wheel guide control arms 13, 14, 15 are in each case articulated to the housing 20 of the transmission unit according to the invention.

From FIGS. 7 to 9 the principle of the mode of action of the transmission unit 5 consisting of the drive pinion 21, the planetary gearwheels 17, 18 and the drive output ring gear 19 is easy to see. The output ring gear 19 is again firmly connected to the wheel hub, while the drive pinion 21 (in this case covered by the planetary carriers 22, 24 at the front in relation to both drawings) sits directly on the driveshaft 11, which in the embodiment illustrated here is connected with wheel guide control arms 13, 14, 15 via a compensation joint 16 to the drive motor (see FIG. 3). It can be seen clearly that—regardless of the deflection movements 9 of the wheel 1—the driveshaft 11 always maintains its fixed vertical relative position in relation to the vehicle chassis, while at the same time there is permanent torque transmission and tooth engagement between the driveshaft 11/drive pinion 21 and the ring gear 19 via the planetary gearwheels 17, 18 each undergoing a pivoting movement 33 about the wheel axis 26. The range of the pivoting movement of the planetary gearwheels 17, 18 is indicated in FIGS. 7 to 9 by the angle segment 33 represented by a dotted line.

Consequently it becomes clear that the invention provides a transmission unit which, while occupying a minimum of structural space, can ensure complete translational de-coupling between a drive input and a drive output, while at the same time the permanent transmission even of high torques or powers can be ensured. Thanks to the invention, in particular it is made possible to completely decouple even powerful wheel-hub motors from the wheel suspension in relation to the jouncing movements of a driven wheel, whereby the unsprung masses of the wheel suspension can be decisively reduced. Furthermore, thanks to the invention exceptionally space-saving wheel-hub drives and wheel suspensions can be produced for motor vehicles of any type.

Thus, the invention makes a decisive contribution in particular toward reducing structural space occupation in the drive-train of motor vehicle drives, extending the application options and improving the driving comfort of wheel-hub drives, especially when used in the context of electric or hybrid drives.

### LIST OF INDEXES

1 Vehicle wheel
2 Tire
3 Rim
4 Wheel-hub drive
5 Transmission unit
6 Drive motor
7 Guide rod
8 Guide sleeve
9 Deflection movement
10 Elastomer bellows
11 Driveshaft, motor shaft
12 Elongated hole
13 Transverse control arm
14 Track rod
15 Transverse control arm, wishbone
16 Shaft compensation joint
17, 18 Planetary gearwheels
19 Ring gear
20 Transmission housing
21 Drive pinion
22-25 Planetary carriers
26 Stub axle
27 Drive output shaft, wheel hub
28, 29 Planetary axes
30 Force flow
31 Locking pins
32 Transmission housing cover
33 Locking slide-way

1-18. (canceled)

19. A transmission unit (5) comprising:
a drive input shaft (11) with a drive pinion (21) and a drive output shaft (27) with an output ring gear (19);
rotational axes of the drive input shaft (11) and the drive output shaft (27) being parallel and the drive input shaft (11) and the drive output shaft (27) being transversally movable relative to one another in a direction (9) that is perpendicular in relation to the rotational axes of the drive input shaft (11) and the drive output shaft (27);
a planetary gearwheel (17) engaging with the drive pinion (21) and the output ring gear (19) and being mounted on a planetary axis (28) of a first planetary carrier (22);
the first planetary carrier (22) being mounted coaxially with the drive pinion (21);
the planetary axis (28) being associated with a second planetary carrier (23) that is mounted coaxially with the output ring gear (19); and
the planetary gearwheel (17) being axially arranged between the first planetary carrier (22) and the second planetary carrier (23).

20. The transmission unit according to claim 19, wherein the planetary axis (28) is common to the first and the second planetary carriers (22, 23) and is formed integrally with one of the first planetary carrier (22) and the second planetary carrier (23).

21. The transmission unit according to claim 19, wherein the first planetary carrier (22) is mounted on the drive input shaft (11) and the second planetary carrier (23) is mounted within the ring gear (19) on the drive output shaft (27).

22. The transmission unit according to claim 19, wherein the first planetary carrier (22) and the second planetary carrier (23) have a same effective radius.

23. The transmission unit according to claim 19, wherein the first and the second planetary carriers (22, 23) are each a pivoting lever having two mounting points.

24. The transmission unit according to claim 19, wherein the transmission units comprises two planetary gearwheels (17, 18) and four planetary carriers (22, 23, 24, 25), each of the two planetary gearwheels (17, 18) is associated with a respective pair of the planetary carriers, and each pair of the planetary carriers comprise a first planetary carrier (22, 24) and a second planetary carrier (23, 25).

25. The transmission unit according to claim 24, wherein the first and the second planetary carriers (24, 25) associated with the second planetary gearwheel (18) are each coaxially mounted on the first and the second planetary carriers (22, 23) associated with the first planetary gearwheel (17).

26. The transmission unit according to claim 19, wherein the transmission unit (5) is integrated in a wheel rim and comprises a wheel drive, and the output ring gear (19) is connected directly to the drive output shaft (27).

27. The transmission unit according to claim 26, wherein the transmission unit (5) is connected directly to a drive motor (6) and is a wheel-hub drive (4).

28. The transmission unit according to claim 27, wherein the drive motor is an electric motor.

29. The transmission unit according to claim 27, wherein a drive shaft of the drive motor (6) forms the drive input shaft (11) of the transmission unit (5), and the drive pinion (21) is arranged on the drive input shaft (11).

30. The transmission unit according to claim 26, wherein the transmission unit (5) is arranged in a wheel carrier (20) that is designed as a transmission housing.

31. The transmission unit according to claim 27, wherein a bellows (10), with a transversal degree of freedom, is arranged between the motor housing (6) and the transmission unit (5).

32. The transmission unit according to claim 19, wherein the transmission unit comprises a linear guide (7, 8) for relative transverse mobility of the drive input shaft (11) and the drive output shaft (27).

33. The transmission unit according to claim 19, wherein the transmission unit (5) is connected to a vehicle chassis by an arrangement of wheel guide control arms (13, 14, 15).

34. The transmission unit according to claim 33, wherein at least one shaft compensation joint (16) is arranged between the drive pinion (21), of the transmission unit (5), and the drive motor (6).

35. The transmission unit according to claim 19, wherein a torsion prevention device (31, 34) is arranged on at least one of the first and the second planetary carriers (22, 24) for preventing at least one of the first and the second planetary carriers (22, 24) from rotating around the drive input shaft (11).

36. The transmission unit according to claim 19, wherein each of the planetary gearwheel (17), the ring gear (19), and the drive pinion (21) are friction wheels.
